(19) United States
(12) Patent Application Publication
(10) Pub. No.: US 2017/0110812 A1
(43) Pub. Date: Apr. 20, 2017

(54) RECEPTACLE ELECTRICAL CONNECTOR FOR IMPROVING MANUFACTURING PROCESS EFFICIENCY

(71) Applicant: Advanced-Connectek Inc., New Taipei City (TW)

(72) Inventors: Yu Lun Tsai, New Taipei City (TW); Pin Yuan Hou, New Taipei City (TW); Chung Fu Liao, New Taipei City (TW); Chuan I Lin, New Taipei City (TW); Dong Xiang, New Taipei City (TW); Da Wei Zhu, New Taipei City (TW); Long Fei Chen, New Taipei City (TW); Rui Su, New Taipei City (TW)

(21) Appl. No.: 15/292,549

(22) Filed: Oct. 13, 2016

(30) Foreign Application Priority Data
Oct. 20, 2015 (CN) 201510677719.3

(51) Int. Cl. H01R 12/57; H01R 13/516; H01R 24/60; H01R 13/6585

(52) U.S. Cl. CPC H01R 12/57; H01R 13/6585; H01R 13/516; H01R 24/60; H01R 2107/00

(57) ABSTRACT

A receptacle electrical connector has an insulative mounting bracket, a first terminal set, a second terminal set, a shielding plate and a shell. The shield plate has two connection portions formed respectively on two opposite sides of the shielding plate and each connection portion 53 has a strip cross section. The strip cross section is formed on the connection portion, and the two strip cross sections of the connection portions are exposed out of two opposite sides of the insulative mounting bracket. During the insert-molding processes of insulative mounting brackets, connecting arms of strips are connected to the strip cross sections of multiple shielding plates for simultaneously forming multiple insulative mounting brackets. Therefore, production efficiency and production rate of the receptacle electrical connectors are enhanced.

### BACKGROUND OF THE INVENTION

1. Field of the Invention

The present invention relates to an electrical connector, and more particularly to a receptacle electrical connector that improves manufacturing process efficiency. During a batch manufacturing process of the receptacle electrical connector, strips are employed to connect multiple shielding plates, and multiple sets of terminals and multiple insulative housing are formed and assembled respectively onto the shielding plates simultaneously by an insert-molding process, which enhances the productivity of the receptacle electrical connector.

2. Description of Related Art

Electrical connectors are general electrical components on electronic devices widely used for connecting to other matching connectors on the other electrical devices. For example universal serial bus (USB) 3.1 connectors are conventional and products that are available and equipped in variety of electronic devices.

USB 3.1 protocol has been further developed to include USB Type C connector that is able to provide ultrahigh data transmission speed of 10 Gbps and has a light and compact structure especially suitable for portable devices. The USB Type C connector is also featured with a reversible socket for reversible connection for extensive applications on different electrical devices.

A USB type C receptacle connector has an insulative housing, a metal plate, two terminal sets and a metal shell. The insulative housing is made of plastic and has a tongue formed on and protrudes from the insulative housing. The metal plate is embedded in the insulative housing by an insert-molding process. The terminal sets are mounted on the insulative housing, are able to transmit signals. The metal shell covers the insulative housing and the terminal sets.

However, each insert-molding process only forms one insulative housing onto one metal plate. To implement batch produce multiple insulative housings, multiple sequential insert-molding processes are required to attach each insulative housing to each metal plate, which is low efficient and disadvantages mass production of the receptacle connectors.

To overcome the shortcomings, the present invention provides a receptacle electrical connector for improving manufacturing process efficiency to mitigate or obviate the aforementioned problems.

### SUMMARY OF THE INVENTION

The main objective of the invention is to provide a receptacle electrical connector that improves manufacturing process efficiency. During a batch manufacturing process of the receptacle electrical connector, strips are employed to connect multiple shielding plates, and multiple sets of terminals and multiple insulative housing are formed and assembled respectively onto the shielding plates simultaneously by an insert-molding process, which enhances the productivity of the receptacle electrical connector.

A receptacle electrical connector in accordance with the present invention comprises an insulative mounting bracket, a first terminal set, a second terminal set, a shielding plate and a shell. The shield plate has two connection portions formed respectively on two opposite sides of the shielding plate and each connection portion 53 has a strip cross section. The strip cross section is formed on the connection portion, and the two strip cross sections of the connection portions are exposed out of two opposite sides of the insulative mounting bracket. During the insert-molding processes of insulative mounting brackets, connecting arms of strips are connected to the strip cross sections of multiple shielding plates for simultaneously forming multiple insulative mounting brackets. Therefore, production efficiency and production rate of the receptacle electrical connectors are enhanced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a receptacle electrical connector for improving manufacturing process efficiency in accordance with the present invention;

FIG. 2 is a perspective view of a semi-finished product of the receptacle electrical connector in FIG. 1 showing connected strip and shielding plate embedded in an insulative mounting bracket after two insert-molding processes are performed;

FIG. 3 is a perspective view of the shielding plate and the strip of the receptacle electrical connector in FIG. 1;

FIG. 4 is a top view of the shielding plate and the strip of the receptacle electrical connector in FIG. 1;

FIG. 5 is a perspective view of the receptacle electrical connector in FIG. 1 skipping a shell and a protection lid;

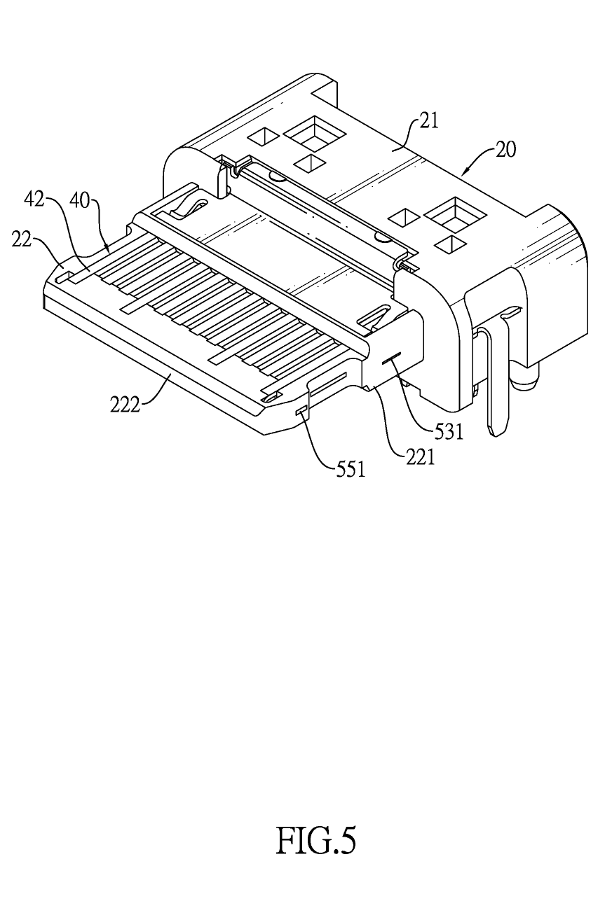

FIG. 6 is an exploded perspective view of the receptacle electrical connector in FIG. 1;

FIG. 7 is another exploded perspective view of the receptacle electrical connector in FIG. 1;

FIG. 8 is a front view of the semi-finished product of the receptacle electrical connector in FIG. 2;

FIG. 9 is a cross sectional side view of the receptacle electrical connector in FIG. 1;

FIG. 10 is a perspective view of a semi-finished product of a second embodiment of a receptacle electrical connector for improving manufacturing process efficiency in accordance with the present invention showing connected strip and shielding plate embedded in an insulative mounting bracket after two insert-molding processes are performed;

FIG. 11 is a perspective view of the shielding plate and the strip of the receptacle electrical connector in FIG. 10; and

FIG. 12 is a top view of the shielding plate and the strip of the receptacle electrical connector in FIG. 10.

### DETAILED DESCRIPTION OF THE PREFERRED EMBODIMENT

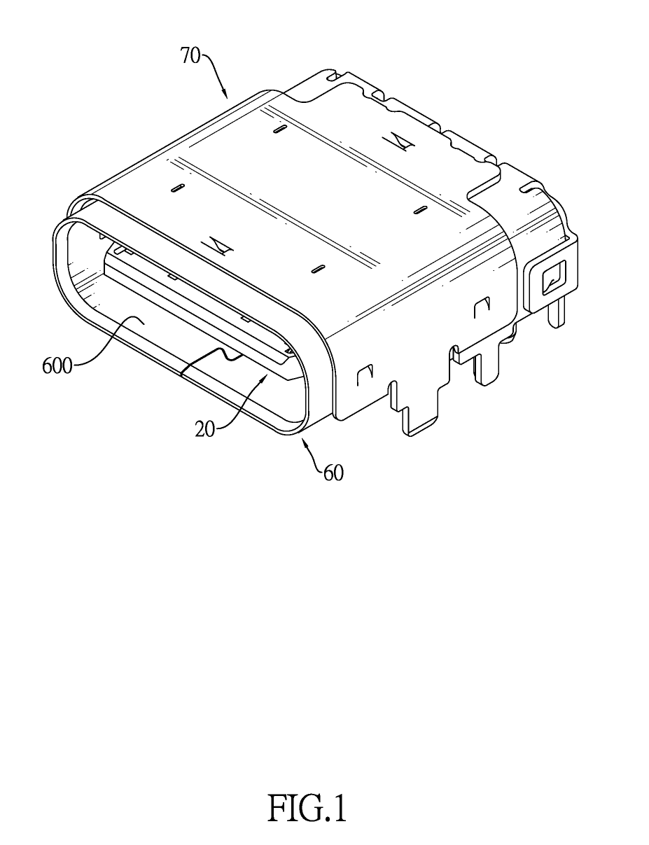

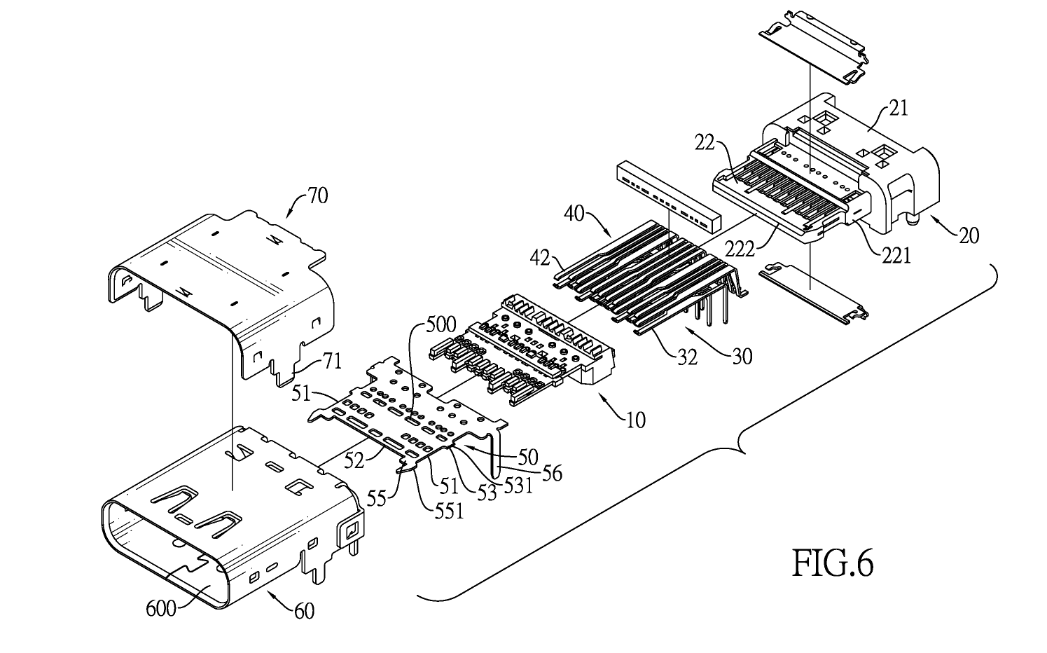

With reference to FIGS. 1 and 6, a first embodiment of a receptacle electrical connector for improving manufacturing process efficiency in accordance with the present invention comprises an insulative mounting bracket, a first terminal set, a second terminal set, a shielding plate 50, a shell 60 and a protection lid 70.

The insulative mounting bracket has an inner insulative housing 10 and an outer insulative housing 20.

The outer insulative housing 20 is mounted on the inner insulative housing 10 and has a base 21 and a tongue 22. The tongue is formed on and protrudes forward from the base 21.

The first terminal set is mounted on the insulative mounting bracket, may be mounted one the inner insulative housing 10 and has multiple first terminals 30. The first terminals 30 are mounted on the insulative mounting bracket, may be mounted on the inner insulative housing 10 and each first terminal 30 has a first electrical contacting section 32. The first electrical contacting section is formed on a front end of the first terminal 30 and is mounted on a bottom surface of the tongue 22.

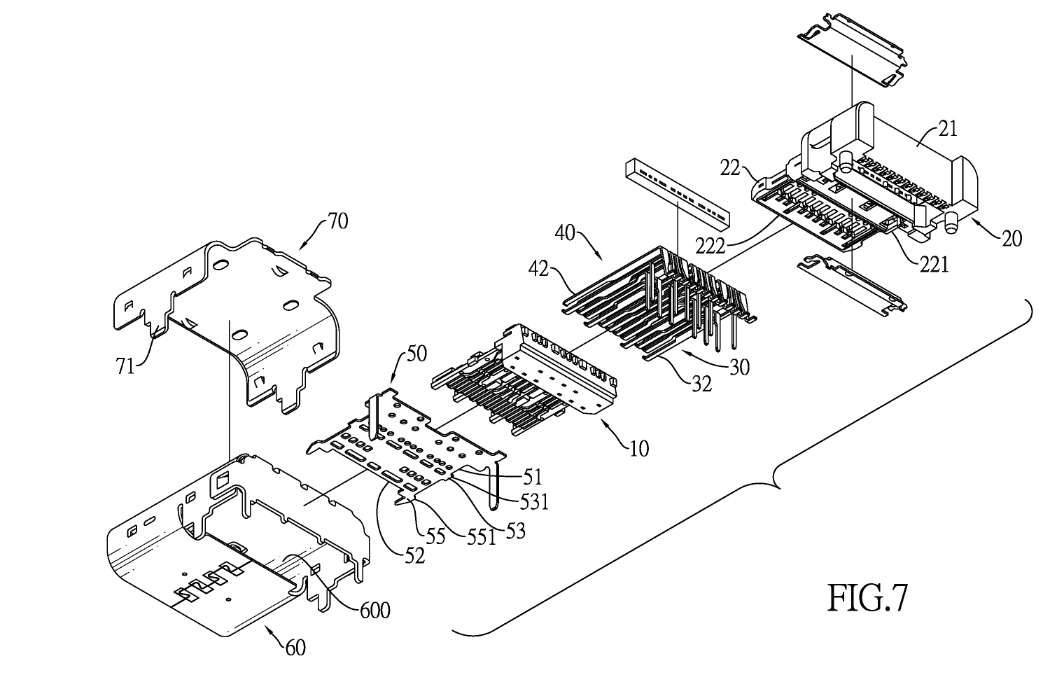

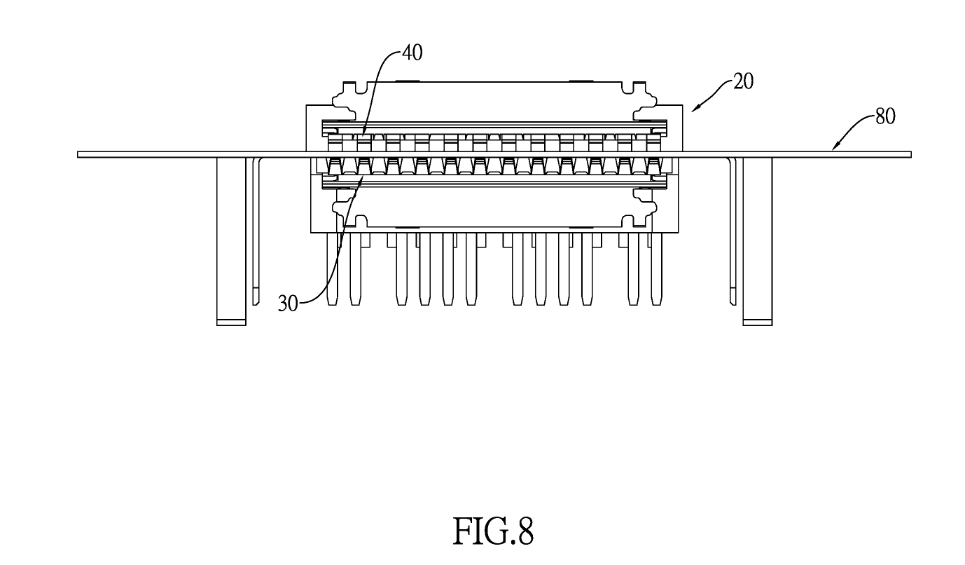

With further reference to FIGS. 7 and 8, the second terminal set is mounted on the insulative mounting bracket, may be mounted on the outer insulative housing 20 and has multiple second terminals 40. The second terminals 40 are mounted on the insulative mounting bracket, may be mounted on the outer insulative housing 20 and each second terminal 40 has a second electrical contacting section 42. The second electrical contacting section 42 is formed on a front end of the second terminal 40 and is mounted on a top surface of the tongue 22.

The first terminal set and the second terminal set are substantially pointing symmetrical to each other with respect to a centre of symmetry of the tongue 22. According to point symmetrical configuration of the first and second terminal sets, when the first and second terminal sets are rotated for 180 degrees with respect to the centre of symmetry, the rotated first and second terminal sets coincide with and are identical to the first and second terminal sets without rotation of 180 degrees. By the point symmetrical configuration of the first and second terminal sets, an electrical plug connector can extend reversely into the reinforced electrical receptacle connector to normally implement high speed signal transmission.

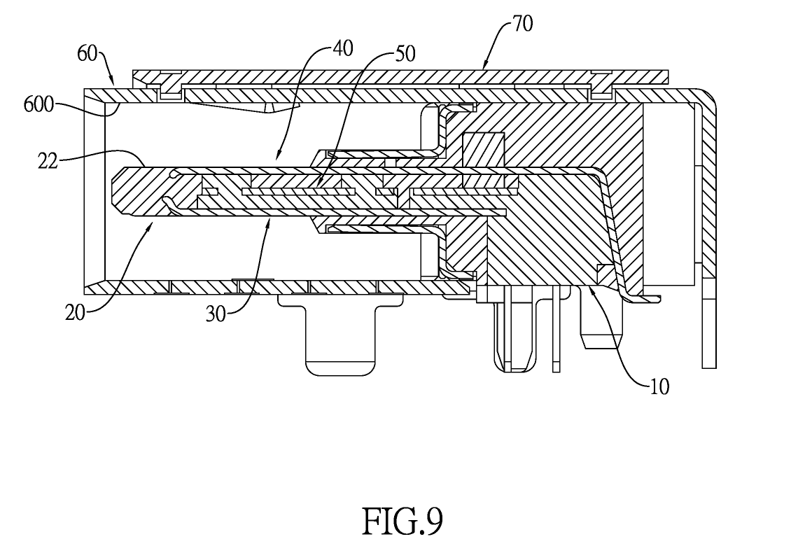

With further reference to FIG. 9, the shielding plate 50 is made of metal, is embedded in the tongue 22 of the insulative mounting bracket, may be embedded in the inner insulative housing 10, is embedded in the tongue 22 of the outer insulative housing 30 of the insulative mounting bracket and is located between the first terminal set and the second terminal set. The shielding plate 50 has two connection portions 53 and two corner reinforcing elements 55.

The connection portions 53 are formed respectively on two opposite sides 51 of the shielding plate 50 and each connection portion 53 has a strip cross section 531. The strip cross section 531 is formed on the connection portion 53, and the two strip cross sections 531 of the connection portions 53 are exposed out of two opposite side edges 221 of the tongue 22. In the first embodiment, the connection portions 53 are formed respectively on and protrude outward from two opposite middle portions of the sides of the shielding plate 50.

The corner reinforcing elements 55 are formed respectively on the sides 51 of the shielding plate 50 adjacent to a front end of the shielding plate 50.

Preferably, the first terminal set and the shielding plate 50 is mounted one the inner insulative housing 10 by a first insert-molding process. After the first insert-molding process, the combined first terminal set, shield plate 50 and inner insulative housing 10 are further mounted on the outer insulative housing 20 by a second insert-molding process.

The shell 60 has a socket cavity 600 defined through the shell 60 and accommodating the inner insulative housing 10 and outer insulative housing 20 of the insulative mounting bracket, the first terminal set and the second terminal set.

The protection lid 70 is mounted on the shell 60 and has two soldering legs formed on two and protruding downward respectively from opposite sides of the protection lid 70 to be soldered on a printed circuit board.

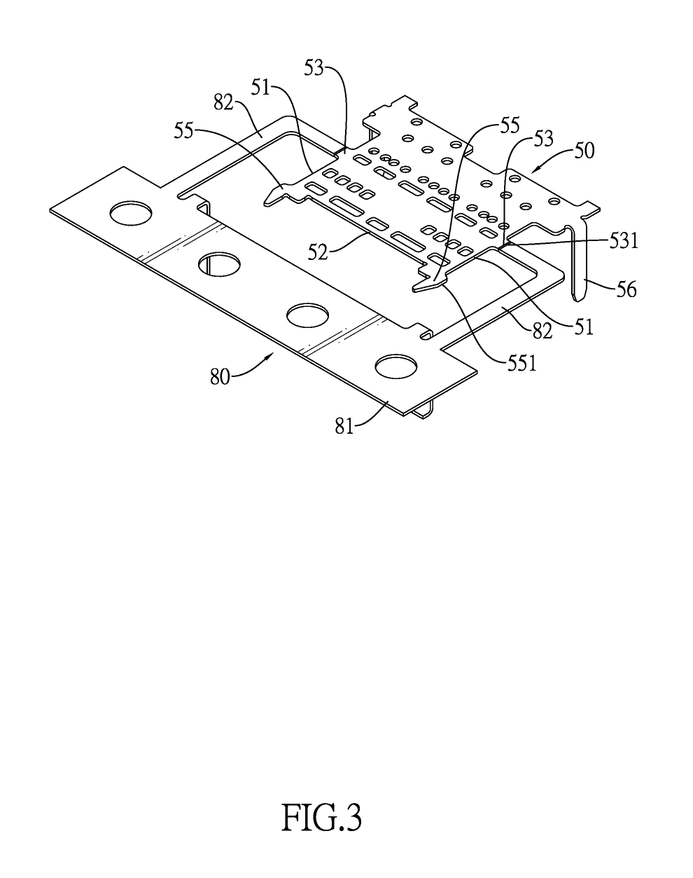

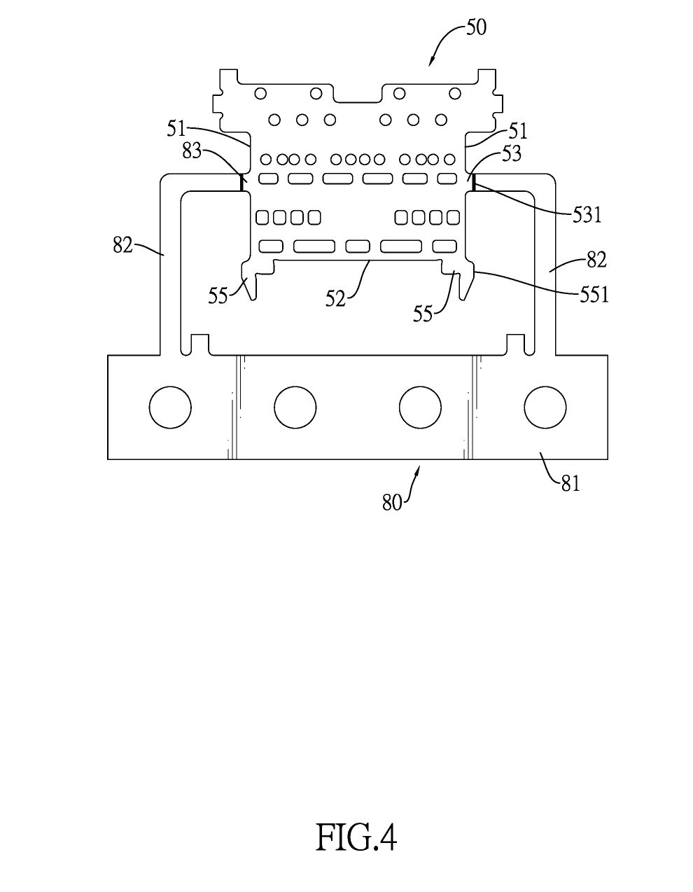

With further reference to FIGS. 3 and 4, during the manufacturing process of the receptacle electrical connector, the strip cross sections 531 of the connection portions 53 of the shielding plate 50 is connected integrally to a metal strip 80. The strip 80 has a connecting plate 81 and a pair of connecting arms 82. The connecting arms 82 are formed on and protrude from the connecting plate 81 and are integrally connected respectively to the strip cross sections 531 of the shielding plate 50. According to requirement of a batch manufacturing process, the connecting plate 81 may be elongated and has multiple pairs of connecting arms 82 to simultaneously connect to multiple shielding plate 50. The strip 80 may be mounted on a fixture device.

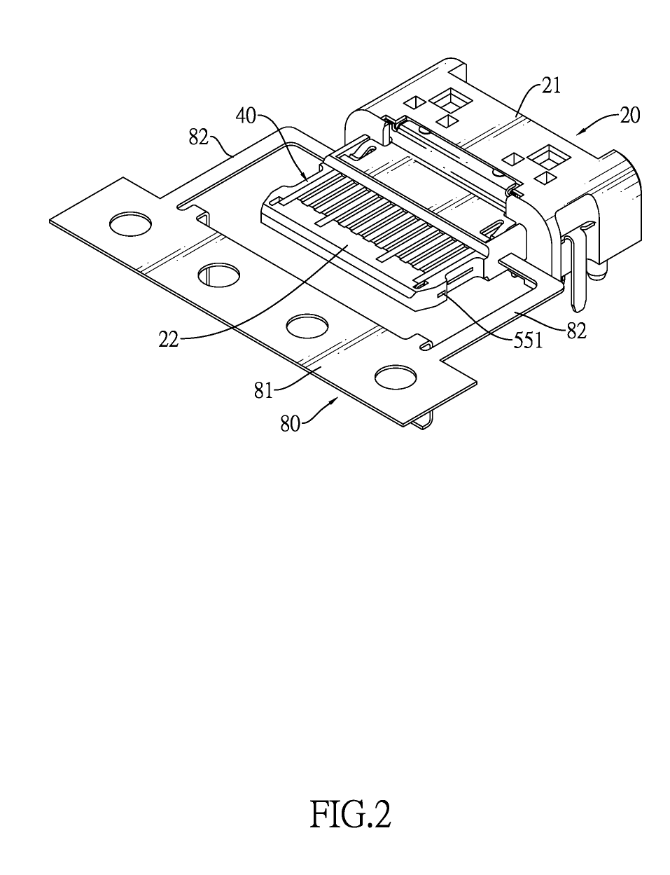

With further reference to FIG. 2, during the batch manufacturing process of the receptacle electrical connector, first of all, multiple first terminal sets are positioned to match multiple shielding plates 50. Then, a first insert-molding process is performed on the multiple first terminal sets and shielding plates 50 by an insert-molding apparatus to simultaneously form multiple inner insulative housings 10. Then, multiple second terminal sets are positioned to match the inner insulative housings 10. A second insert-molding process is performed to simultaneously form multiple outer insulative housings 20 on the inner insulative housings and the second terminal sets. Finally, a cutting tool is used to cut connecting portions between the shielding plates 50 and the strips 80 such that strip cross section 531 on two opposite sides 51 of each shielding plate 50 are formed.

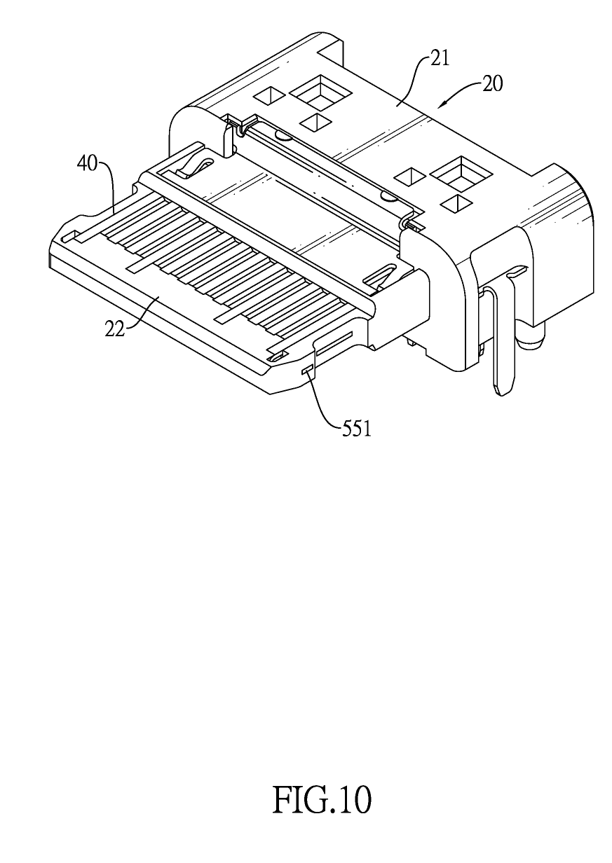

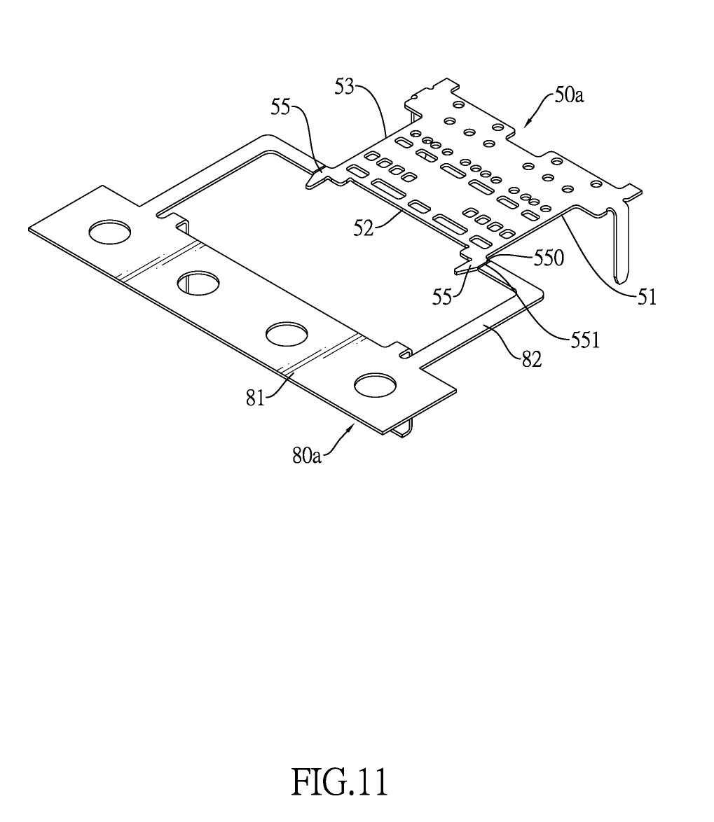

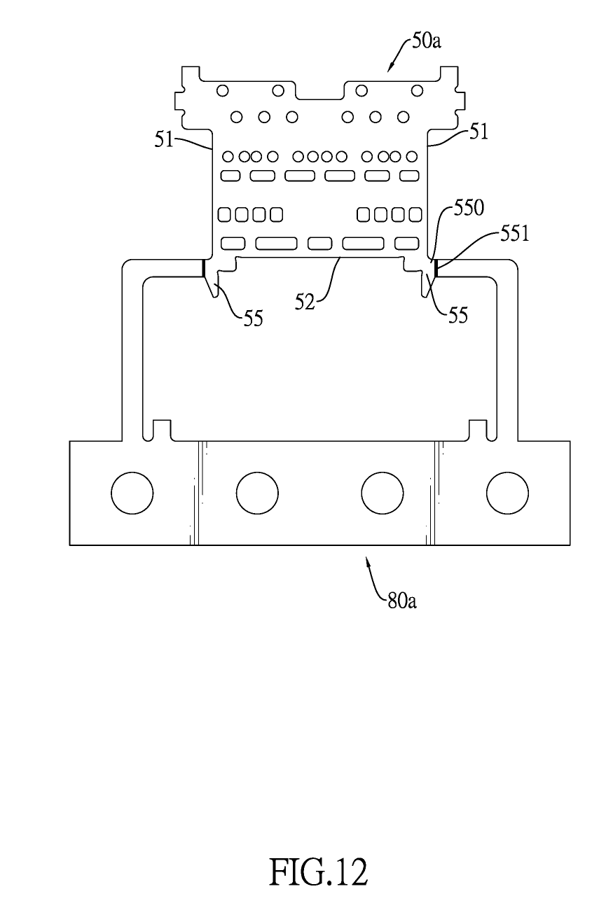

With reference to FIGS. 10 to 12, a second embodiment of the receptacle electrical connector for improving manufacturing process efficiency in accordance with the present invention, the shielding plate 50a has two corner reinforcing elements 55 formed respectively on the opposite sides 51 adjacent to a front end of the shielding plate 50a. The connection portions 550 are formed respectively on the corner reinforcing elements 55. The strip cross sections 551 are formed respectively on the connection portions 550 of the corner reinforcing elements 55 and are exposed out of the side edges 221 of the tongue 22 adjacent to a front edge 222 of the tongue 22. During the insert-molding processes, the connecting arms 82 of the strip 80a are connected to the strip cross sections 551 of the corner reinforcing elements 55.

The receptacle electrical connectors in accordance with the present invention are made by connecting a single strip 80 integrally to multiple shielding plates 50 to simultaneously insert-mold and form multiple inner insulative housing 10 and multiple outer insulative houses 20. Therefore, the insert-molding time is decreased drastically to achieve batch production of the receptacle electrical connector.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A receptacle electrical connector comprising:
an insulative mounting bracket having
a base; and
a tongue formed on and protruding forward from the base;
a first terminal set mounted on the insulative mounting bracket and having multiple first terminals mounted on the insulative mounting bracket and each first terminal having a first electrical contacting section formed on a front end of the first terminal and mounted on a bottom surface of the tongue;
a second terminal set on the insulative mounting bracket and having multiple second terminals mounted on the insulative mounting bracket and each second terminal having a second electrical contacting section formed on a front end of the second terminal and mounted on a top surface of the tongue, wherein the first terminal set and the second terminal set are substantially pointing symmetrical to each other with respect to a centre of symmetry of the tongue;
a shielding plate embedded in the tongue of the insulative mounting bracket, located between the first terminal set and the second terminal set and having two connection portions formed respectively on two opposite sides of the shielding plate and each connection portion having a strip cross section formed on the connection portion, and the two strip cross sections of the connection portions exposed out of two opposite side edges of the tongue; and
a shell having a socket cavity defined through the shell and accommodating the insulative mounting bracket, the first terminal set and the second terminal set.

2. The receptacle electrical connector as claimed in claim 1,wherein the insulative housing has
an inner insulative housing; and
an outer insulative housing mounted on the inner insulative housing, wherein the base and the tongue are formed on the outer insulative housing.

3. The receptacle electrical connector as claimed in claim 2, wherein the connection portions are formed respectively on and protrude outward from two opposite middle portions of the sides of the shielding plate.

4. The receptacle electrical connector as claimed in claim 3, wherein the shielding plate further has two corner reinforcing elements formed respectively on the sides of the shielding plate adjacent to a front end of the shielding plate.

5. The receptacle electrical connector as claimed in claim 2, wherein
the shielding plate further has two corner reinforcing elements formed respectively on the sides of the shielding plate adjacent to a front end of the shielding plate; and
the connection portions are formed respectively on the corner reinforcing elements; and
the strip cross sections are formed respectively on the connection portions of the corner reinforcing elements and are exposed out of the side edges of the tongue adjacent to a front edge of the tongue.

6. The receptacle electrical connector as claimed in claim 2, wherein the first terminal set and the shielding plate 50 is mounted one the inner insulative housing 10 by a first insert-molding process.

7. The receptacle electrical connector as claimed in claim 3, wherein after the first insert-molding process, the first terminal set, shield plate and inner insulative housing are further mounted on the outer insulative housing by a second insert-molding process.

8. The receptacle electrical connector as claimed in claim 7 further comprising a protection lid mounted on the shell and having two soldering legs formed on two and protruding downward respectively from opposite sides of the protection lid.
